(19) United States
(12) Patent Application Publication
(10) Pub. No.: US 2005/0055310 A1
(43) Pub. Date: Mar. 10, 2005

(54) Method and system for accessing information within a database

(76) Inventors: David Carl Drewett, Nokomis, FL (US); Jeffery Alan Dean, Sarasota, FL (US)

Correspondence Address: Hoffman, Wasson & Gitler, P.C.;Crystal Center 2, Suite 522, 2461 South Clark Street, Arlington, VA, 22202, US

(21) Appl. No.: 10/838,216

(22) Filed: May 5, 2004

Related U.S. Application Data
(60) Provisional application No. 60/481,341, filed on Sep. 8, 2003.

(51) Int. Cl. G06F 17/60

(52) U.S. Cl. 705/50

(57) ABSTRACT

A method and system for allowing individuals to be provided with information using an interactive voice response system as well as a database and web server for checking an identification code provided to the system by the individual as well as affording the individual the ability to designate the type of communication that the individual will receive from the system, based upon various prompts generated by the system.

### CROSS REFERENCE TO RELATED APPLICATIONS

The present application claims the priority under 35 U.S.C. §19(e) to provisional patent application Ser. No. 60/481,341, filed on Sep. 8, 2003, the disclosure of which is hereby incorporated by reference.

### BACKGROUND OF THE INVENTION

1. Field of the Invention

The present invention is directed to a system and method of accessing material within a database, particularly utilizing an interactive voice response (IVR) system to communicate between the system and a potential user. Although the present invention can be employed in many fields of commercial use, for ease of understanding, the invention will be described with respect to the real estate industry.

2. Discussion of the Prior Art

The information age is ubiquitous in nature, allowing information to be provided to a user in many varied ways using many different types of technologies. For example, the internet, and its various search engines such as Yahoo and Google would allow the average person, having access to a personal computer, to request information on an almost infinite number of topics. This information would then be relayed to the user virtually instantaneously. While this information could contain the answers to a multitude of trivia type questions, it is also afforded service industries, such as the real estate industry with a new tool for disseminating information relating to the availability and attributes of a particular listed property.

For example, when most single family dwellings are initially listed for sale or rent, a sign is erected on or near that property, generally listing the real estate company to which that property has been listed as well as a real estate agent in that company. Since many of the real estate companies have their own website, the prospective buyer could utilize the internet to endeavor to learn more information about that particular property. Unless the prospective buyer was in possession of a laptop computer having wireless communication capabilities, the prospective buyer would not be afforded instant access to the real estate company's website. The prospective buyer could alternatively call the real estate agent listed on the sign to obtain additional information as well as to schedule a showing of that property. However, as can be appreciated, the real estate agent might not be available when the prospective buyer initially makes the telephone call and potential sales might be lost. Therefore, if a method and system for allowing a potential buyer instant access to the appropriate information as well as to automatically schedule a showing with a real estate agent would be developed, it would greatly enhance the possibility of a sale. This is particularly true in instances in which the prospective buyer immediately calls the real estate agent utilizing a mobile phone once they discover a property that might be of interest to them. This system could also be utilized to obtain data relating to the property from a database.

Various systems have been developed for the selective retrieval of data from a remote database. For example, U.S. Pat. No. 6,094,753, issued to Heinonen et al discloses a system and method for retrieving information from a database. The database comprises data relating to a number of different services and service users. The user would present a predetermined code to the system received from the database. The database would then provide the user with information by a voice message or by short messages. However, this system employs a caller line identification (CLI) automatically transmitted at the point when the subscriber telecommunicates with the system. The subscriber also provides a code for obtaining information from a health care database. It is noted that there is no interaction between the subscriber and the database other than providing the database with the appropriate CLI given to the subscriber device through an intelligent card as-well as the additional code.

U.S. Patent Application Publication 2002/0019243, to Zhang et al, discloses a short message service gateway system and method for providing information service for mobile phones. In one embodiment, the gateway system receives a short message from a mobile phone, fetches an information service code from the short message, and according to the information service code, obtains the results of the information service from at least one application server. These results of the information service are then combined into a short message and sent to the mobile phone. However, as was true with respect to the Heinonen et al patent, there is no verbal interaction between the user and the database.

U.S. Patent Application Publication 2002/002485 and 2003/0144016, both to Kolsky et al disclose systems and methods for object access to a cellular telephone. Using a cell phone, a user enters an objective identifier. The phone then connects to an object identifier resolution server which processes the object identifier. Once the connection has been initiated, the server processes the object identifier in order to locate the requested object. After the server identifies the object, at least one interactive communication, such as a menu, is sent to the cell phone. As was true with respect to the above-noted references, the patent application publications to Kolsky et al do not utilize an interactive voice response platform.

U.S. Patent Application Publication 2003/0064705, to Desiderio is directed to a real estate information system and method for accessing multiple listing service (MLS) and other property specific information from remote databases. In one embodiment, a portable electronic device (PED) such as a laptop is enabled with GPS capabilities and two-way wireless communications for accessing and receiving real estate related information. The PED is adapted to display the location and street address associated with individual properties, which information is used to identify select particular properties of interest. It is important to note that there is no interactive verbal communication between a potential buyer and the real estate agent.

U.S. Patent Application Publication 2003/0211845, to Lohtia et al details a wireless data information service for allowing users to obtain specific data information by dialing predetermined telephone number digits or a feature code. Users dial the predetermined feature code or phone number on their wireless handset which is routed to a wireless web information gateway. The gateway determines what information is being requested and then collects that information from the appropriate source. Information is then sent to the user's handset via SMS or microbrowser message. Similar to the previously described prior art, the patent application publication to Lohtia et al does not utilize an interactive voice browser to the internet.

### SUMMARY OF THE INVENTION

The present invention overcomes the deficiencies of the prior art by providing a method and system employing an interactive speech recognition system allowing a potential buyer to obtain information relating to a listed real estate property as well as allowing a real estate company or real estate agent to quickly and automatically respond to an inquiry made by a potential buyer. The system would also operate to automatically schedule a showing of the property to the potential buyer.

The potential buyer would dial a telephone number displayed on a sign giving notice that a particular property is for rent or sale. This telephone number, which is generally toll free, could also be provided in a newspaper listing, an advertisement, or the like. The telephone call would be received from an interactive voice response (IVR) system located at a remote location, in communication with the potential buyer. The IVR would also be in communication with a database as well as a web server system. The database and the web server system could be located proximate with the IVR or at a remote location. Although this system is predominantly designed to employ mobile phone technology, any method of communicating with this system utilizing a non-mobile phone, a telephone system through the internet or a personal computer or laptop, could also be utilized.

Once the prospective buyer initiates a verbal communication utilizing the defined telephone number, or a defined e-mail address, the prospective buyer is prompted to enter a particular code relating to the specific property of interest. The particular code would be prominently displayed on the aforementioned sign associated with the property, or other types or advertisements. Although the present invention is designed as an interactive verbal system, it is noted that information can be relayed to the user using a non-verbal communication technique as well as non-verbally prompting the user.

Once the code is entered, it will be compared to information provided in the database. If the code is identical to information provided in the database, the prospective buyer would be prompted to respond to different questions, or would be directly given information relating to the property. For example, if the prospective buyer's elicited response was to set up a showing of the particular property of interest, an appointment could directly be made during the initial communication between the prospective buyer and the system of the present invention, be it telephonic or otherwise.

The prospective buyer would then be directed to indicate to the system how further communications from the system to the prospective buyer should proceed. For example, the prospective might wish to receive communication from the system to the prospective buyer's mobile or cellular telephone, or a non-mobile telephone. Additionally, the prospective buyer could request that a text message be sent to the prospective buyer's mobile or cellular-phone. Furthermore, such communication could be directed to the prospective buyer by a fax or an e-mail.

Information relating to the prospective buyer garnered through the prospective buyer's telephone number or information elicited from these prospective buyer during the initial or subsequent communication would be retained by the system, in a manner allowing each respective real estate agent or company to access this information, and to insure that communication is maintained between the prospective buyer and the real estate agent or broker, through the present system.

### BRIEF DESCRIPTION OF THE DRAWINGS

The invention will now be more fully understood by reference to the following detailed description of the invention in conjunction with the drawings, of which:

FIG. 1 is a generalized block diagram of the present invention;

FIG. 2 is a generalized flow diagram of the method according to the present invention;

FIG. 3 is a detailed block diagram of the present invention; and

FIG. 4 is a detailed diagram of the database system according to the present invention.

### DETAILED DESCRIPTION OF THE INVENTION

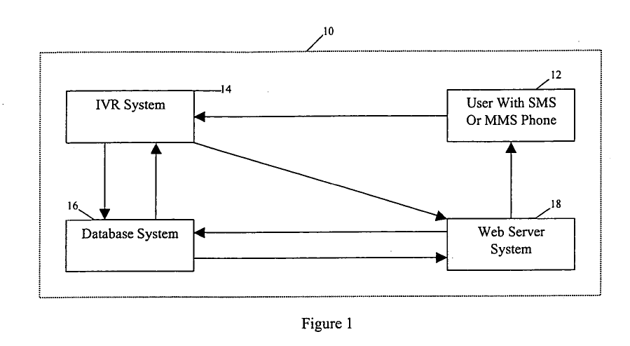

FIG. 1 illustrates the major components of the present invention 10. These components include a communication device allowing a prospective buyer to contact the system of the present invention. This communication device 12 could include a short message service (SMS), a multimedia messaging service (MMS) phone as well as a standard touch-tone phone. Additionally the communication device could include a direct connection from the prospective buyer's personal computer or laptop. If a personal computer or laptop would be utilized, the prospective buyer would utilize the keyboard or similar device to log on to the website of the present invention, or to initiate a telephone call from the computer. While a computer input device could be utilized, we shall explain the operation of the present device based upon the prospective buyer employing an SMS or MMS phone. As previously described, a toll-free telephone number would be advertised along with an identification code with respect to a particular property. This toll-free telephone number would be included on sign advertising that that particular property is for sale or rent, as well as being included in a newspaper or similar advertisement.

At a location remote from the prospective buyer, the present invention would employ an interactive voice response (IVR) system which would be initially contacted by dialing the toll-free telephone number. The IVR system 14 is a technology that automates interaction with telephone callers. The IVR can be utilized by various enterprises to reduce the cost of common sales, service, collections, inquiry and support calls to and from their particular company. Although historically, the IVR has utilized prerecorded menus to present information and options to callers by touch tone telephone keyboard entries, the IVR system utilized by the present invention would enable input and responses to be gathered via the spoken word employing voice recognition technology. Once the telephone call is initiated by the prospective buyer, it will be answered by the IVR system 14. The prospective buyer would speak or key in by an appropriate keypad, the identification code of the particular property of interest. This identification code would be sent to a database system 16 wired or wirelessly connected to the IVR system 14. The database system 16 would then conduct a search to determine whether the entered identification code was included in the database. An appropriate response from the database 16 to the IVR system 14 would then ensue based upon the results of the identification code submitted by the prospective buyer. If no match is found, communication between the system of the present invention and the prospective user would be terminated, or, alternatively, the caller would be prompted to check the identification code and re-enter in the system. If a match was found, the identification code and in a number of cases, additional information would be transmitted from the IVR system 14 to a web server system 18 which is in wired or wireless communication with both the IVR system 14 as well as the database system 16. Information relating to the identification code submitted by the prospective buyer would be transmitted from the database system 16 to the web server system 18. The results of the search conducted by the database system as relayed to the web server system 18 would in turn be relayed to the prospective buyer's telephone or other receiving device.

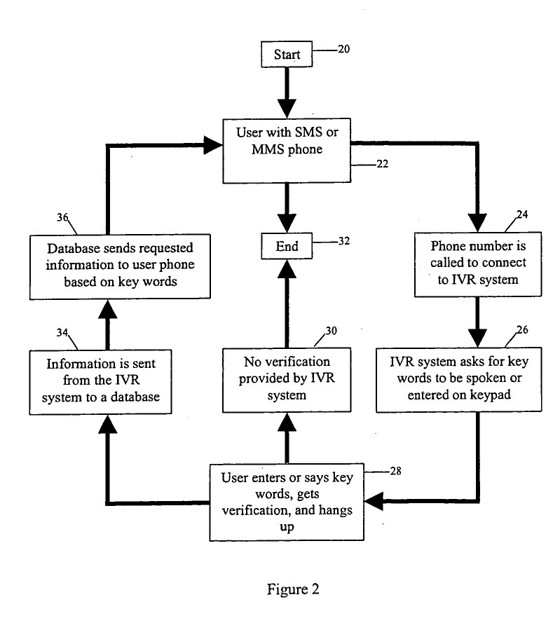

The method of utilizing the system according to the present invention will now be described with respect to FIG. 2. Although the teachings of the present invention can be utilized in many different fields, for ease of explanation, we shall describe the operation of the present invention in a real estate context. The process begins by having a prospective buyer become interested in a particular piece of property to be purchased or to be rented. Generally, a sign would be erected on or near the property that has been listed. This sign would include, among other information, a toll free telephone number as well as an identification code directly associated with that piece of property. Alternatively, the identification code might be general in nature and is associated with a particular real estate company or agent. If this is the case, the prospective buyer would key in or enunciate an identifier associated with that property, such as its address or apartment number. Additionally, it is noted that the identification code could be included in an advertisement or property listings provided in a newspaper or similar media.

Once the prospective buyer becomes interested in a property at step 20, they would contact the system of the present invention using an SMS or MMS phone or other types of communication devices at step 22. Although this step indicates the utilization of these two types of communication, it is envisioned that additional types of communication such as the utilization of a laptop or personal computer to relay information from the prospective buyer to the system could also be utilized. However, for simplicity sake, we will limit the description of the present invention to the use of the SMS or MMS phones. We will also limit our discussion to the situation in which the prospective buyer utilizes a keypad to dial the toll free number. Once this number is called at step 24, the prospective buyer would be connected to the IVR system 14 (see FIG. 1). The IVR system would then prompt the prospective user to enter the identification code of the particular property of interest by verbally enunciating the identification code or by entering the identification code using the appropriate keypad at step 26. Once the identification code is entered by the prospective buyer at step 28, this code would be sent to the database system 16 for comparison to identification codes provided in its memory as shown by step 34. If no match is found based upon the identification code provided by the prospective buyer, the database 16 would send a message to the IVR system 14 at step 30, at which time the IVR system is disconnected from the prospective buyer's phone at step 32, or the caller would be prompted to check and re-enter the identification code.

Alternatively, if a match is found in the database system 16, the web server system 18 would transmit information to the user's phone at step 36. Once this occurs, and this information has been verbally relayed to the user's SMS or MMS phone, the communication would be ended at step 32.

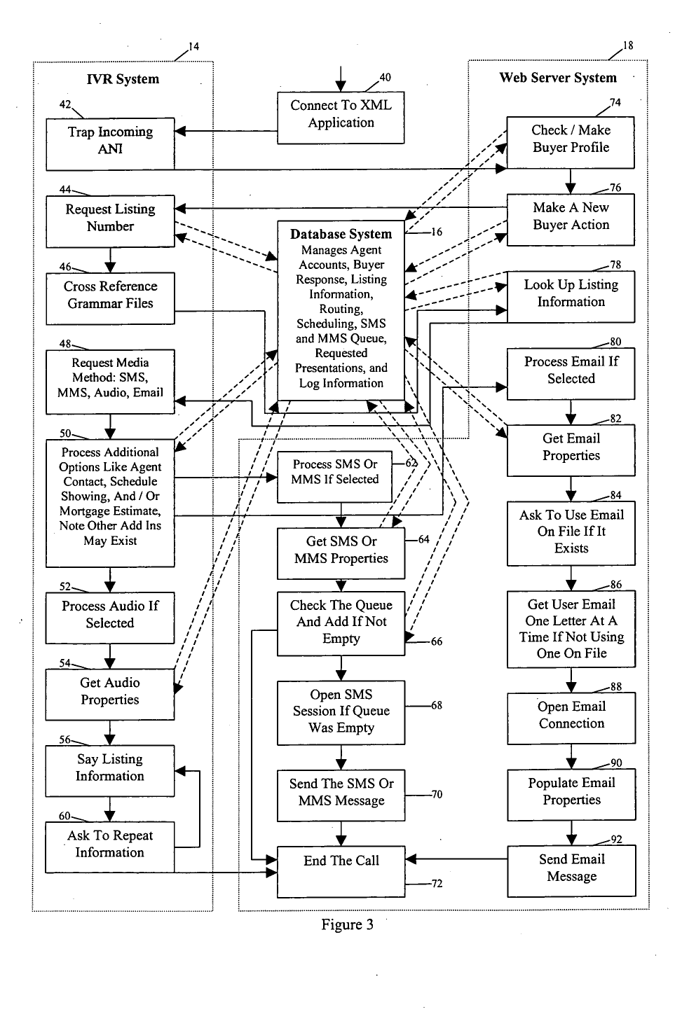

A more detailed description of the system according to the present invention is shown in FIG. 3 in which like reference numerals have been maintained. This figure includes the IVR system 14, the database system 16 as well as the web server system 18. The IVR system 14 employs an XML base scripting language utilized to determine the wording of the IVR system and expected input from the prospective buyer. Once the prospective buyer is connected to the IVR system 14 by dialing the appropriate number from a cell phone, land line phone or similar device, the prospective buyer is connected at 40 to the IVR system 14. The caller's telephone number would be retained utilizing a standard ANI at 42.

The caller's telephone number is immediately transmitted to the web server system 18 for the purpose of retaining the telephone number as well as checking the telephone number at box 74 to determine whether this is the initial instance of that telephone number accessing the system. This is done by checking the appropriate information in the database system 16. If it is determined by the database system 16 that this is an initial telephone call, the web server system is informed of this situation and prepares a buyer profile at 74. Although this buyer profile might only contain the calling parties telephone number, additional information could be included in the buyer's profile, such as the area in which the telephone call was placed, based upon the area code. If this was the first telephone call initiated by the prospective buyer, the web server system would compile a new buyer action at 76. This is important for tracking purposes, since it is conceivable that the prospective buyer would call from the same telephone number requesting information or a number of properties. Once the web server system at 76 initiates a new buyer action, it contacts the IVR system 14 at 44 to prompt the prospective buyer to provide it with the identification code of a particular property. Although, as indicated hereinabove, it is possible for the prospective buyer to enter this identification code utilizing the appropriate keypad on his or her telephone, we will assume, for the purposes of the present invention that the identification code is verbally provided to the system from the prospective buyer. At this point, the voice recognition system included in the IVR system 42 would check the enunciated identification code to ensure that it matches possible verbal inputs at 46 utilizing reference grammar files. A digital output of a matched voice utterance would be sent to the database 16 as well as to the web server system 18 at box 78 to look up the appropriate listing information. This information from the database lookup can be any amount of text, video, or audio and is only limited by what the prospective buyer's telephone or other communication device would accept.

The teachings of the present invention including the information provided in the database would be tailored to the type of possible responses generated by the matching of the identification code with information provided in the database, as will be described in more detail hereinbelow. One of the features of the present invention would be to schedule a showing of the particular property based upon the matching of the identification code with information provided in the database, as well as to provide additional information relating to the property, mortgage rates or the real estate company itself. Therefore, to accomplish this result, once lookup information is discovered in the database and relayed to the web server system at 78, the web server system would communicate with the IVR 14 at 48 to prompt the IVR to elicit from the prospective buyer the manner in which additional communication will be transmitted. These types of communications can be through the SMS/MMS system, audio in nature or by e-mail. Once the prospective buyer has chosen the appropriate media, additional options or scheduling particulars would be prompted by the IVR system. For example, a showing can be automatically scheduled utilizing the information provided by the prospective buyer as well as information included in the database system 16 relating to scheduling. The real estate company or real estate agent would provide the system of the present invention with possible appointment times for each of the properties listed. One or more of these times could then be suggested to the prospective buyer. If, however, the prospective buyer attempts to schedule a showing at a time not available to the real estate company or real estate agent, the present invention would attempt to schedule the showing at a time convenient to both parties. Information relating to the scheduled showing would be relayed to the prospective buyer as well as be maintained in the database system 16 in a manner allowing the real estate company or agent to check the website of the present invention or would be informed of this showing by appropriate media, such as a telephone call, e-mail or the like. Other types of options open to the prospective buyer, would include but not be limited to directly contacting the agent as well as being provided with mortgage estimates at 50. Once a showing of the property has been confirmed, the database will be appropriately changed to reflect this appointment as well as to ensure that the appointed time would not be allocated for that property to a second prospective buyer.

Assuming that the prospective buyer selects an audio response as the manner to receive information at 52, the database 16 would be contacted by the IVR system at box 54 to obtain the proper audio properties assisting in the recognition of a word or number enunciated by the buyer. The prospective buyer would be asked to say the listing information at 56 as well as to repeat this information at 60 to ensure that it was properly received. Particularly if the prospective buyer utilizes the audio media as a response, boxes 54, 56 and 60 could be included in the request listing number 44. Once all of the appropriate audio options are prompted to the prospective buyer, the system would end the call at 72. Information processed during the prospective buyer initiated call would be retained in a database system including the prospective buyer's telephone number. Information received by the system could automatically generate a courtesy call using the features of the present invention thanking the prospective buyer for his or her interest.

If the prospective buyer selects the SMS/MMS option at box 52, the web server 18 would obtain the appropriate SMS/MMS properties from the database system 16 at box 64. A queue would be established at box 66 and a check would be made to determine whether that queue is empty. An SMS/MMS session would then be opened at 68 if the queue was empty and the appropriate SMS/MMS message would be sent at 70. Once this was accomplished, the call would be ended.

Similarly, if the e-mail option was elected at box 80, the web server systems 18 would obtain the e-mail properties from the database system 16 and would inquire as to whether an e-mail file exists at 84. If an e-mail address was unavailable, this address would be obtained at 86 at which time an e-mail connection would be made at 88/90 and an e-mail message would be sent at 92.

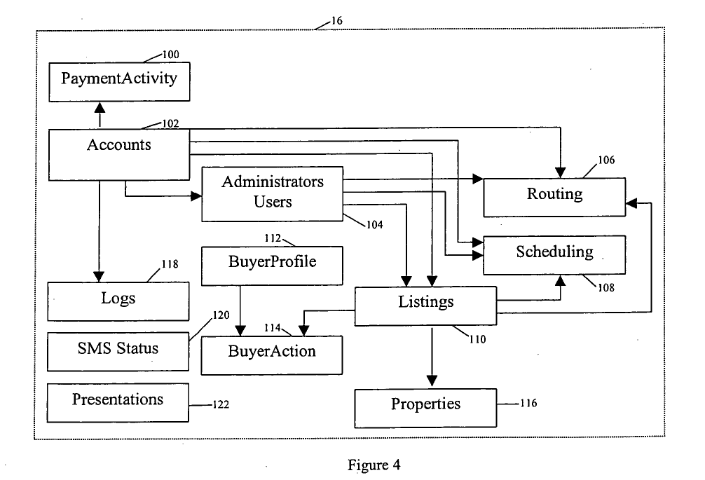

FIG. 4 illustrates in more detail the database system 16 utilized by the present invention. This database system includes the buyer profile 112 and buyer action 114 created when a prospective buyer initially makes a telephone call to the toll free number of the present invention. The database also includes the particular identification codes for each of the properties for all of the users of the system. Additional material relating to each of these properties would be included in the database memory at 116.

The database memory 16 would also include an accounts section 102 being used both as an internal mechanism by the present invention as well as a manner in which each of the accounts such as a real estate company or real estate agent can access information relating to the number and types of telephone inquiries received by the system for one or more of their properties. The payment activity of each of the accounts is also included at 100. The present invention can maintain logs at 118 specifically checking on the number and kinds of transactions occurring in the system. Based upon the types of users employing the system, a separate section 104 would be used to help administer the operation of the system. This would include routing information based upon telephone calls generated by prospective buyers at 106 as well as scheduling a showing at 108.

An SMS/MMS status check section 120 is also included. This section can be monitored by the present invention to ensure the proper operation of the system. The system also includes a mechanism at 122 for providing prospective clients with presentations relating to the operation of the present invention.

The network of the present invention would support any type of appropriate platform. Voice middleware supports any VXML, ASR or TTS, XML, SIP and SOAP.

While the invention has been described in terms of preferred embodiments, those skilled in the art will recognize that the invention can be practiced with various modifications. For example, based upon the technology utilized by the present invention as well as the technology in the prospective buyer's possession, once a particular property was identified, additional information relating to the property including, but not limited to various interior and exterior views of the property could be provided to the prospective buyer, along with an audio presentation. This additional information can be sent directly to the prospective buyer's cell phone, computer or the like.

1. A system for enabling an individual access to information included in a remote database, comprising:
an entering device for inputting a non-personal identification code;
a receiving device receiving said non-personal identification code;
a database provided with a memory containing stored identification codes and information associated with each of said stored identification codes;
a device for determining the existence of information in said database based upon comparing said non-personal identification code with said stored identification codes included in said database; and
a device for relaying information to the individual associated with a match of said non-personal identification code with said stored identification codes.

2. The system in accordance with claim 1, wherein each of said non-personal identification codes and each of said stored identification codes is associated with a real estate property.

3. The system in accordance with claim 1, wherein said receiving device is provided with a voice recognition system.

4. The system in accordance with claim 2, wherein said receiving device is provided with a voice recognition system.

5. The system in accordance with claim 3, wherein said voice recognition system includes a device for verbally prompting the individual to verbally enter information, including said non-personal identification code into said receiving device.

6. The system in accordance with claim 4, wherein said voice recognition system includes a device for verbally prompting the individual to verbally enter information, including said non-personal identification code into said receiving device.

7. The system in accordance with claim 5, wherein said voice recognition system produces a digital word based upon the information entered by the individual, said digital word transmitted to said database to determine the existence of a match between said non-personal identification code and said stored identification codes.

8. The system in accordance with claim 6, wherein said voice recognition system produces a digital word based upon the information entered by the individual, said digital word transmitted to said database to determine the existence of a match between said non-personal identification code and said stored identification codes.

9. The system in accordance with claim 5, further including a web server for communicating with said database and the individual, through said entering device.

10. The system in accordance with claim 6, further including a web server for communicating with said database and the individual, through said entering device.

11. The system in accordance with claim 9, wherein said device for verbally prompting the individual prompts the individual to enter a mode of communication between said web server and the individual.

12. The system in accordance with claim 10, wherein said device for verbally prompting the individual prompts the individual to enter a mode of communication between said web server and the individual.

13. The system in accordance with claim 11, wherein said mode of communication is by SMS/MMS.

14. The system in accordance with claim 12, wherein said mode of communication is by SMS/MMS.

15. The system in accordance with claim 11, wherein said mode of communication is by e-mail.

16. The system in accordance with claim 12, wherein said mode of communication is by e-mail.

17. The system in accordance with claim 11, wherein said mode of communication is by facsimile transmission.

18. The system in accordance with claim 12, wherein said mode of communication is by facsimile transmission.

19. The system in accordance with claim 2, wherein said database is provided with information for automatically scheduling an appointment time to view the real estate property associated with a particular one of said non-personal identification codes.

20. The system in accordance with claim 10, wherein said database is provided with information for automatically scheduling an appointment time to view the real estate property associated with a particular one of said non-personal identification codes.

21. The system in accordance with claim 20, wherein said appointment time is automatically relayed to the individual.

22. The system in accordance with claim 21, wherein the individual is relayed said appointment time by SMS/MMS.

23. The system in accordance with claim 21, wherein the individual is relayed said appointment time by e-mail.

24. The system in accordance with claim 21, wherein the individual is relayed said appointment time by facsimile transmission.

25. The system in accordance with claim 10, wherein said entering device is a telephone, and further wherein the calling number of said entering device is captured by said receiving device and transmitted to said web server.

26. The system in accordance with claim 10, wherein information regarding a real estate property associated with one of said non-personal identification does is directly relayed to the individual entering said non-personal identification code.

27. A method of an individual accessing information relating to real estate properties, including the steps of:
assigning a non-personal identification code to each of the real estate properties;
advertising each of said non-personal identification codes with its associated real estate property;
providing information within a memory of a database relating to each of the real estate properties, said database including each of said non-personal identification codes;
contacting a receiving device in communication with said database;
entering a non-personal identification code received by said receiving device;
comparing the entered non-personal identification code with said non-personal identification codes included in said memory of said database; and
transmitting information to the individual relating to the particular real estate property associated with said entered non-personal identification code.

28. The method in accordance with claim 27, further including the steps of:
providing a voice recognition device in communication with said database; and
verbally prompting the individual to enter one of the said non-personal identification codes.

29. The method in accordance with claim 28, further including the step of the individual verbally entering one of said non-personal identification codes.

30. The method in accordance with claim 28, further including the step of verbally prompting the individual to enter a mode of subsequent communication with the individual.

31. The method in accordance with claim 30, further including the step of the individual verbally entering said mode of subsequent communication.

32. The method in accordance with claim 27, further including the step of automatically scheduling an appointment time for the individual to view the real estate property associated with said entered non-personal identification code.
